(19) United States
(12) Patent Application Publication
(10) Pub. No.: US 2003/0014314 A1
(43) Pub. Date: Jan. 16, 2003

(54) Manufacturing flow control method and system

(75) Inventors: Justin Griep, Denver, CO (US); Scot Darr, Denver, CO (US); Arthur K. Stone III, Longmont, CO (US); David B. Gleditsch, Loveland, CO (US); John F. Szemler, Denver, CO (US); Creg Pike, Ft. Collins, CO (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: PELION SYSTEMS, INC., Lafayette, CO

(21) Appl. No.: 10/097,247

(22) Filed: Mar. 15, 2002

Related U.S. Application Data
(60) Provisional application No. 60/275,697, filed on Mar. 15, 2001.

(51) Int. Cl. G06F 17/60

(52) U.S. Cl. 705/15

(57) ABSTRACT

A method and system for performing managed workflow including communication between (1) a consumption point for at least one material and (2) at least one supply point for the at least one material. Tracking of the replenishment of the at least one material enables a workflow management system to assess compliance with at least one of performance and conformance. Tracking includes the utilization of flow control (e.g., Kanban) techniques for inventory management.

The present application claims priority to U.S. Provisional Patent Application Ser. No. 60/275,697, filed Mar. 15, 2001, the contents of which are incorporated herein by reference.

### BACKGROUND OF THE INVENTION

1. Field of the Invention

The present invention is directed to a method and system for performing manufacturing work flow, and, in one embodiment, to a method and system for performing collaborative manufacturing work flow utilizing electronic tracking of consumable materials.

2. Discussion of the Background

Kanban in Japanese means “visible signal.” Kanban signals are essentially demand signals from the customer, both external to and internal within the manufacturing or business process using them. These Kanban demand signals authorize the beginning of work and, in effect, control the level of work in process and the lead-time for products. The use of these visible signals facilitates immediate feedback on abnormalities in the process to be addressed by immediate intervention activities or process improvement efforts. The application of Kanban to improve workflow in both manufacturing and office environments is a common practice as described in Lean Manufacturing—Tools, Techniques, and How to Use Them by William M. Feld, 2001. The contents of Mr. Feld's book are incorporated herein by reference. Examples of how Kanban signals can be applied include: (1) containers going empty, (2) cards being pulled when parts are used, (3) locations on a factory floor becoming empty when parts are used, (4) barcodes or transmitters being read when actions have happened, (5) a weighing system tripping a limit switch that a container has gone “emptier” than a threshold, and (6) an on-hand inventory level on the inventory management system going below a certain level.

Kanban and Just-In-Time (JIT) manufacturing methods gained international awareness as Japanese manufacturers gained significant market shares for their products due to superior quality and costs in the 1970's. Detailed studies of these methods such as the Toyota Production System (TPS) showed that the use of “pull” versus “push” production methods, driving production based upon actual events, not forecasted events, combined with a relentless effort to eliminate waste, and only produce what is needed for the very short-term time horizon. This drove a response capability and discipline throughout the entire manufacturing process and supply chain that was superior to Western manufacturing's MRP, scheduled, batch-production methods. As Kanban methods, with short time horizons for manufacturing execution and reduced factory cycle times from waste elimination were deployed, the velocity of materials throughout the manufacturing process increased dramatically resulting in much higher inventory turnover rates and much lower levels of inventory in the stockroom, work-in-progress, and finished goods inventory. This lead to a popular analogy where high inventory levels were compared to high water levels in a river and process problems were referred to as large rocks in the river, initially submerged by the inventory or water levels. As inventory (or water) is pulled out of the river, process problems (or rocks) become exposed and visible for solution. The World Class Manufacturing: The Lessons of Simplicity Applied by Richard J. Schonberger, 1986 discloses that “inventory turns provide comparable anecdotal evidence of the level of performance of a company regardless of changes in economic swings, monetary policies, trade practices, or internal company manipulations. It happens that when a company manages its processes poorly, waste in the form of inventory piles up.” The contents of Mr. Schonberger's book are incorportated herein by reference.

In the 1980's IBM introduced the Continuous Flow Manufacturing concept which built upon JIT manufacturing best practices but improved upon what was perceived as a trial and error process improvement method of exposing process problems by pulling inventory out of the system, to one of line and material analysis to anticipate where process problems will occur and take preventative corrective action. Various flow manufacturing and lean enterprise methods continued to formalize these improvement processes in the 1990's and business process reengineering took the concepts of cycle time reduction, elimination of waste, and flow into non-manufacturing processes such as the office. Supply chain management (SCM) of the 1990's allows all of the firms in the supply chain to look beyond their own objectives to the objective of maximizing the final customer's satisfaction. SCM attempts to align the processes from initial raw materials to the ultimate consumption of the finished product linking across supplier-user companies. The combination of the best practices of these process improvement techniques is known today as lean flow manufacturing.

Material Requirement Planning (MRP) and Enterprise Requirement Planning (ERP) computer planning systems that were broadly introduced in the 1970's were not designed with continuous flow and lean manufacturing concepts in mind. MRP/ERP systems are forecast and schedule material and production (or “push”) as opposed to responding to actual demands or being actual event driven (or “pull”). The use of MRP forecasting algorithms such as economic order quantity (EOQ) to execute material replenishment or product build schedules often results in large production run quantities and high levels of inventory in the process. Further, newer supply chain management and advanced planning system applications focus on managing products throughout the supply chain with a focus on finished goods inventory investments and the computer management of those investments throughout warehouse and distribution systems within the supply chain network. These concepts of forecasted replenishment and finished goods inventory as a driver for supporting customers works in opposition of the lean flow manufacturing techniques described above.

Although Kanban is known to have been used generally, it is believed that such previous attempts have been highly manual and labor-intensive. Because it has required a high level of manual oversight, people stop using the system, allow it to become outdated, and run the risk of shutting down the production process.

General background to manufacturing systems and methods can also be found in: Japanese Manufacturing Techniques—Nine Hidden Lessons in Simplicity by Richard Schonberger, 1982, ISBN 0-02-929100-3; Zero Inventories by Robert W. Hall, 1983, ISBN 0-87094-461-4; Just-In-Time Breakthrough, by Edward J. Hay, 1988, ISBN 0-471-85413-1; America Can Compete, by Gooch et al., 1987, Library of congress Card Number 86-083329; Reinventing the Factory Productivity Breakthrough in Manufacturing Today, by Harmon et al., 1990, ISBN 0-02-913861-2; Against Time—How Time-Based Competition is Reshaping Global Markets, by Stalk et al., 1990, ISBN 0-02-915291-7; Non-Stock Production—The Shingo System for Continuous Improvement, by Shigeo Shingo, 1988, ISBN 0-915299-30-5; Just-In-Time for Operators, by the Productivity Press Development Team, 1998, ISBN 1-56327-133-8; Just-In-Time Manufacturing Excellence, by Costanza et al, 1986, ISBN 0-9619783-0-9; Basics of Supply Chain Management by Fredendall et al., 2001, ISBN 1-57444-120-5; and Factory Physics, 2^{nd} Edition, by Hopp et al., 2001, ISBN 0-256-24795-1. The contents of those references are incorporated herein by reference.

### SUMMARY OF THE INVENTION

A unique challenge exists in the fact that most manufacturing companies are committed to MRP/ERP software applications to run their business and the costs and risks associated with removing those systems is prohibitive. Therefore, a solution is needed that can deliver the flow manufacturing benefits desired, while automating what has been a highly manual and variable approach to lean flow manufacturing, while integrating with and not replacing the overall MRP/ERP applications. Kanban technologies, combined with lean flow supply chain cycle time reductions, permit driving manufacturing processes closer to real as opposed to anticipated demand. The combination (1) provides less risk of stock-outs and production interruptions through the use of empirical methods, and (2) enables clear visibility and messaging dialogues with suppliers that can lead to the desired high velocities of materials and resulting high rates of inventory turnover that Schonberger correlated with World Class Manufacturing.

Accordingly, the present invention addresses ease of use and maintenance problems with known methods to develop, analyze and manage systems utilizing flow principles. One such flow principle is the use of product synchronizations for use in determining resource sizes or the number of required resources (e.g., on a manufacturing line).

According to one aspect of the present invention, much of the work of calculating and maintaining Kanbans is automated, dramatically reducing the manual work and frequency of printing, placing, and auditing hundreds and thousands of Kanban cards. In addition, the system of the present invention can visibly track the status of the parts being replenished. Within that tracking environment, a messaging system for different customer/supplier teams within the replenishment system is used to have a dialogue and take necessary actions. It is also possible to reconcile the simple manual tools of Kanban with the ERP logic to manage the purchasing and payment processes with suppliers.

These and other objects of the present invention are addressed using a system that monitors parts or materials consumption and dispatches (e.g., electronically) replenishment requests to suppliers. By keeping a sufficient quantity of materials on hand that actually fit the demand of arriving orders, a workflow process is improved.

In another embodiment of the present invention, a computerized system is used to design and maintain Kanban material replenishment systems as well as signal internal and external suppliers of materials and products closely based upon actual demand derived from customers purchasing end products. Such a system is less dependent upon traditional forecasted or scheduling methods of anticipating when the demand for end products will occur.

According to another aspect of the present invention, a system provides Kanbans supporting computer-based, event-driven flow systems designed to automate an actual usage, thereby providing unique statusing visibility and messaging linkages between customer/supplier relationships, linking customer demand-driven production planning with Kanban material replenishment throughout the supply chain, and reconciling Kanban-driven manufacturing events with traditional MRP/ERP future planning, purchasing, and inventory control applications.

### BRIEF DESCRIPTION OF THE DRAWINGS

A more complete appreciation of the invention and many of the attendant advantages thereof will become readily apparent with reference to the following detailed description, particularly when considered in conjunction with the accompanying drawings, in which:

FIG. 1 shows the integration of the manufacturer, the manufacture's ERP or MRP system, customers, and suppliers;

FIG. 2 is a state transition diagram showing a series of states that a good notification request may use during a lifetime of a good request;

FIG. 3 is a screen capture showing a how a purchaser may use an exemplary CFM system views and update a signal;

FIG. 4 is a screen capture showing a supplier viewing a series of signals;

FIG. 5 is a screen capture showing a timeline being setup for an exemplary CFM system;

FIG. 6 is a screen capture showing an example of an email-based replenishment signal;

FIGS. 7 and 8 are completed Kanban sizing reports;

FIG. 9 is a screen capture of an exemplary Kanban card;

FIG. 10A is a graphical illustration of the legend for FIG. 10B;

FIG. 10B is an exemplary graphical product synchronization diagram;

FIGS. 11 and 12 are screen captures of the results of two exemplary resource calculations;

FIG. 13 is a screen capture showing an example of a graphical mixed-model product synchronization;

FIG. 14 is a schematic illustration of a computer system for implementing at a portion of the present invention in a computer-implemented embodiment; and

FIG. 15 is a flow diagram for an exemplary system.

### DETAILED DESCRIPTION OF THE PREFERRED EMBODIMENTS

The present invention is directed to a set of components that may be implemented in hardware or in software, and in a distributed or a centralized manner. As described hereinafter, those components will be referred to as a Collaborative Flow Manufacturing (CFM) Applications Suite. However, it is to be understood that all the functionality of the components may be implemented in a single program. Likewise, the components may be written by various vendors and need not actually be marketed or sold as a suite.

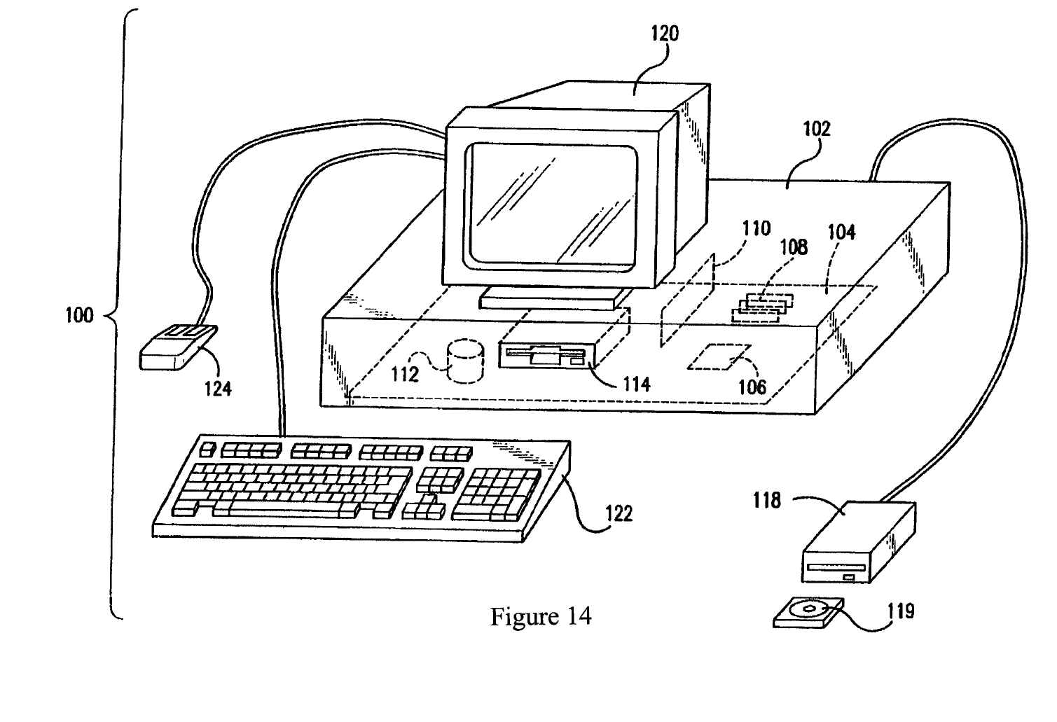

A computer 100 (FIG. 14) includes a computer housing 102 that houses a motherboard 104. The motherboard 104 includes a CPU 106 (e.g., Intel 80x86, Motorola 68x0, or PowerPC), memory 108 (e.g., DRAM, ROM, EPROM, EEPROM, SRAM, SDRAM, and Flash RAM), and other optional special purpose logic devices (e.g., ASICs) or configurable logic devices (e.g., GAL and reprogrammable FPGA). The controlling computer 100 also includes plural input devices, (e.g., a keyboard 122 and mouse 124), and a display card 110 for controlling monitor 120. In addition, the computer system 100 further includes magnetic or optical storage devices. Such storage devices include, but are not limited to, a floppy disk drive 114; compact disc reader 118, tape; and a hard disk 112, any of which are connected using an appropriate device bus (e.g., a SCSI bus, an Enhanced IDE bus, or an Ultra DMA bus). Also connected to the same device bus or another device bus, the computer 100 may additionally include a compact disc reader/writer unit (not shown) or a compact disc jukebox (not shown). Although a compact disc 119 is shown in a CD caddy, the compact disc 119 can be inserted directly into CD-ROM drives that do not require caddies. In addition, a printer (not shown) also provides printed listings of operations of the present invention.

As stated above, the system includes at least one computer readable medium. Examples of computer readable media are compact discs 119, hard disks 112, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling both the hardware of the computer 100 and for enabling the computer 100 to interact with a human user. Such software may include, but is not limited to, device drivers, operating systems and user applications, such as development tools. Such computer readable media further includes the computer program product of the present invention for controlling a manufacturing process. The phrase “computer code devices” as used herein can be either interpreted or executable code mechanisms, including but not limited to scripts, interpreters, dynamic link libraries, subroutines, Java methods and/or classes, and partial or complete executable programs. Moreover, although portions of the specification describe the operation of portions of the present invention in terms of a microprocessor and a specially programmed memory, one of ordinary skill in the art will appreciate that a portion of or all of those described functions may be implemented in a configurable logic device. Such a logic device may be either a one-time programmable (OTP) logic device or a field programmable gate array (FGPA). It will also be appreciated by one of ordinary skill in the art that a single computer code device and/or logic device may implement more than one of the described functions without departing from the spirit of the present invention.

The Collaborative Flow Manufacturing (CFM) Applications Suite was developed to design, optimize, and execute flow throughout the value chain and on the factory floor. The primary customer that will deploy a CFM system is a manufacturer. The applications are designed to first provide tools for redesigning factory operations as dictated by Collaborative Flow Manufacturing methodology. The applications then execute and optimize the day-to-day operation of a CFM system including the integration of customers and suppliers to provide the most benefit. Integration with customers and suppliers can simply be notification and web browser interaction or fully automated with systems integration. Existing ERP or MRP systems are not supplanted by CFM and are, instead, integrated with the data and workflows of each of the applications.

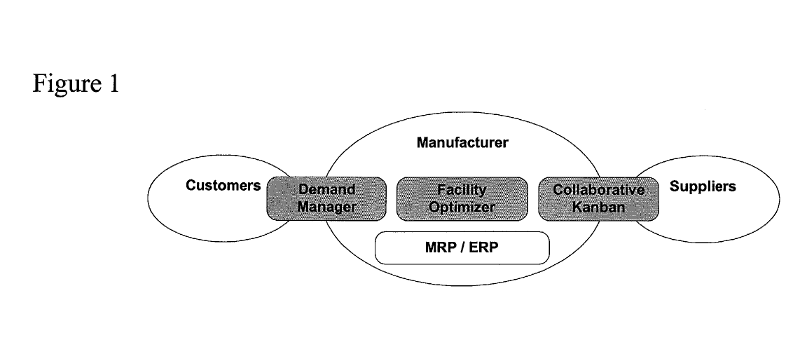

FIG. 1 shows the integration of the manufacturer, the manufacture's ERP or MRP system, customers, and suppliers. The major business components of the manufacturer are shaded and demonstrate which components interact with suppliers and customers.

### Facility Optimizer

The primary purpose of the Facility Optimizer is the design and optimization of the layout and operations on a factory floor. This is done according to Collaborative Flow Manufacturing principles and produces an ideal factory floor layout of processes for mixed model lines, sequence of events, process definition, and sizes for machine and labor resources. This information can be utilized by the Demand Manager for accurately calculating production schedules.

### Collaborative Kanban

The Collaborative Kanban provides the services necessary to effectively use Kanban-based replenishment both internally to the manufacturing line and externally with suppliers. Kanban sizes are based on variable levels of demand and bill of material explosions and can dynamically adapt to changing business conditions. Kanban cards are provided for internal Kanban signaling. Multiple techniques of integration with suppliers for external Kanban signals are provided depending on supplier participation level. These external Kanban signals are managed throughout their lifecycle by the Collaborative Kanban component.

Planners can be alerted to exceptional scenarios that may cause material shortages or other problem. Suppliers are rated by performance and conformance, providing vital information to manufacturers.

### Demand Manager

Integration of customers with a manufacturer and driving demand to factory floor is handled by the Demand Manager. Collaborative Flow Manufacturing is a demand or pull-based solution as opposed to a traditional push or forecast-based scheduling in MRP systems today. To accommodate this, the Demand Manager manages, schedules, and sequences demand to the line. This provides manufacturers with a realistic production schedule and the ability to drive production-based on demand. The Demand Manager also feeds back to the Collaborative Kanban component demand levels that can effectively optimize Kanban sizing.

### Material Replenishment

Traditional forecast systems push a schedule of products to produce and materials to replenish based upon an estimate of future and current needs. In contrast, CFM is a demand-based system that pulls products through processes based on the actual customer demand. Materials are consumed when a “visible signal” exists, not based on some forecasted event that may or may not actually occur. Demand-based replenishment of materials can produce more optimal inventory levels and reduce material shortages.

As a result, Kanban is an important tool in a demand-based system. CFM automates the process of calculating and managing Kanban signals. In addition, the Collaborative Kanban features of CFM apply sophisticated signaling tools to be applied to traditional Kanban systems in order to increase the speed and responsiveness.

In a manufacturing environment, these benefits apply to not only to purchased parts, but also to manufactured assemblies “pulled” through a factory. In an office environment, these Kanban benefits apply to the flow of documents (paper or electronic) as well as to information or intellectual property.

An important use of CFM for Kanban is to signal demand within the facility producing the product or providing the service. CFM calculates the number of parts that should be in a container or units in a location to facilitate this process.

Another function of CFM is to apply Kanban methodology to signal replenishment from one facility to another. This is most often used in relationships with suppliers or vendors. When a manufacturer needs to replenish a given material, a signal is initiated to start the replenishment process. The CFM system enables communication, tracking of the signals through their lifecycle, and measuring the performance of the replenishment. This is handled by the Collaborative Kanban component of the CFM system.

### Replenishment Signals

Each signal is initiated by a consumption point where a given material or resource is depleted to a point that it will require replenishment. The signal is delivered to a specific supply point from which the material or resource will be obtained. There may be a choice of supply points for a particular material or resource. Selection of a supply point to signal may be manual or automated by the system using specific selection criteria. A signal may also be split in to multiple signals to fulfill replenishment from more than one supply point.

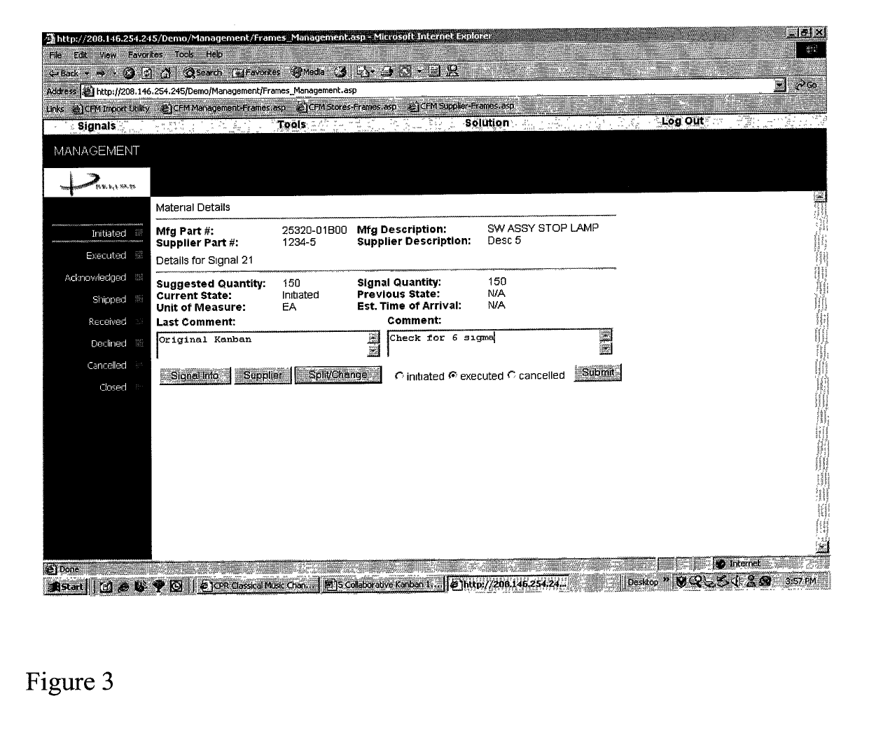

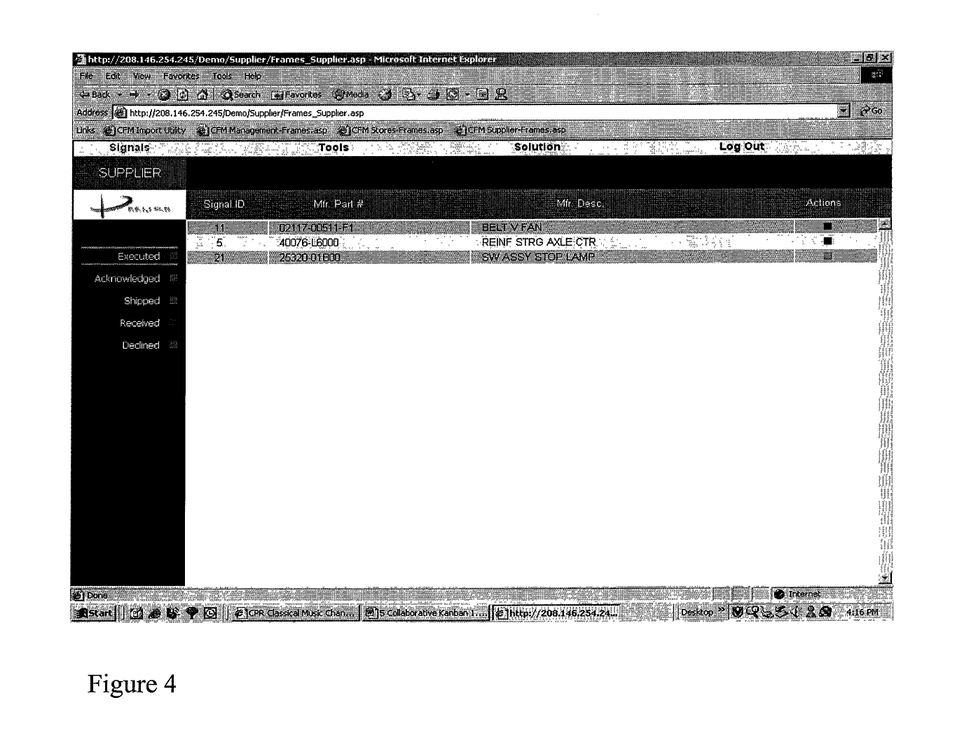

Signals can contain many kinds of information that are useful to the replenishment process. The most basic information is what the consumption point is requesting. This might include a part number, quantity, description, and the consumption point. Additional information attached to a signal may include messages being sent from the supply point to the consumption point to communicate on any issues arising during the replenishment process. A supply point may also what to adjust the quantity which the consumption point could choose to accept. As this signal information is being updated the changes are recorded in the system's database. FIG. 3 shows a how a purchaser using the CFM system views and updates a signal. FIG. 4 shows a supplier viewing a series of signals.

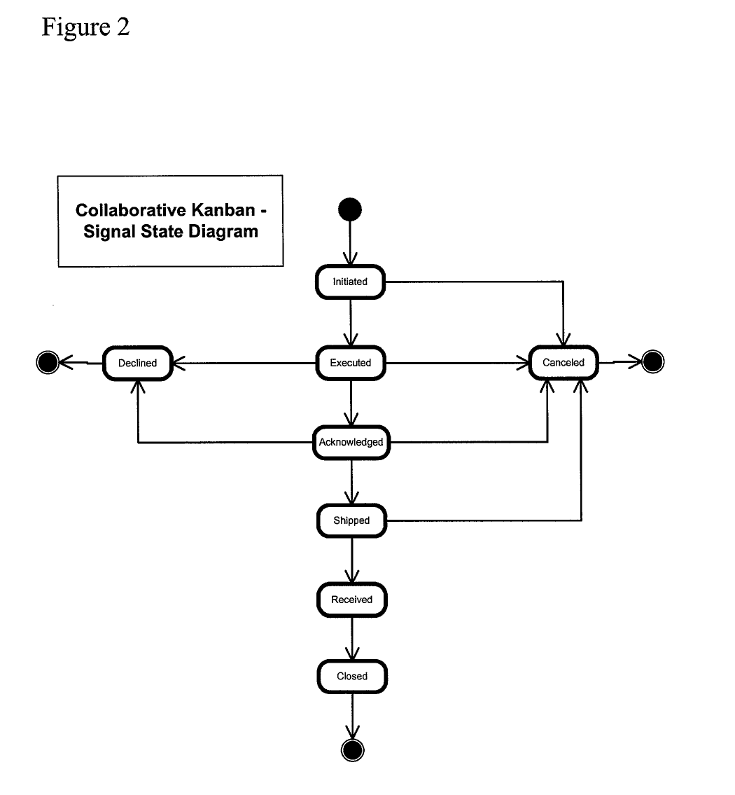

Each signal goes through a lifecycle as the replenishment is in process. During this lifecycle, the signal can go through a series of states. An exemplary set of states is shown in the state transition diagram shown in FIG. 2. These states are:

| | |
|---|---|
| Initiated | The signal has been created due to some triggering event, |
| | such as an empty bin or inventory level is below |
| | a threshold. |
| Executed | A supply point has been selected and a notification will |
| | be sent to the supply point. |
| Acknowledged | The supply point has acknowledged that it has received |
| | and can deliver on the replenishment requested in |
| | the signal. |
| Shipped | The supply point has now shipped the materials or |
| | resources requested, back to the consumption point and |
| | it is in transit. A supply point may also ship more than |
| | once to fulfill the total of the request. |
| Received | Materials or resources have been received to fulfill |
| | on this signal. Signals may stay in a received state while |
| | multiple shipments arrive. |
| Closed | Once the replenishment request by the consumption point |
| | has been fulfilled, the signal is then closed. |
| Cancelled | During the process the consumption point, for whatever |
| | reason, may decide to cancel the replenishment signal. |
| Declined | If the supply point cannot fulfill the requested |
| | replenishment, the supply point will decline the signal. |
| | The consumption point may decide to send the signal |
| | to a different supply point. |

Using the signal states, a timeline can be constructed for replenishment.

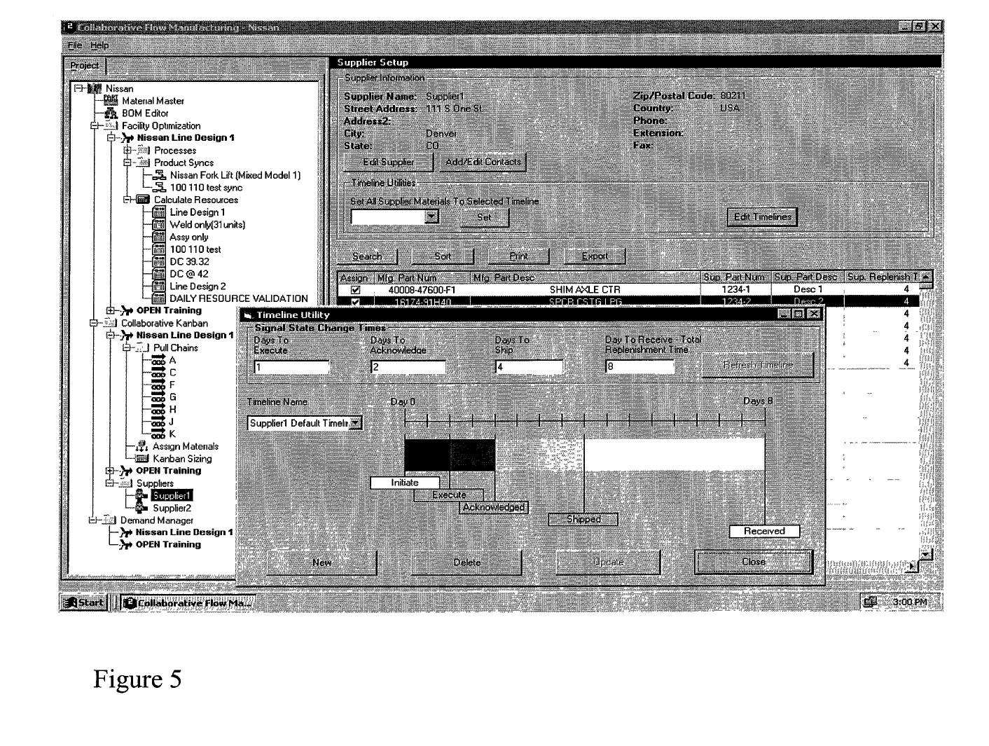

The main states of the signal can be given an expected amount of time from initiation to when that state should occur. This information can then be used to alert the consumption and supply points when a replenishment is falling behind schedule and may require intervention. Timelines are typically assigned to a specific supply point and a specific material I resource. The next section will also show how the timeline can be used for rating time-based performance of replenishment. FIG. 5 shows a timeline being setup in the CFM system.

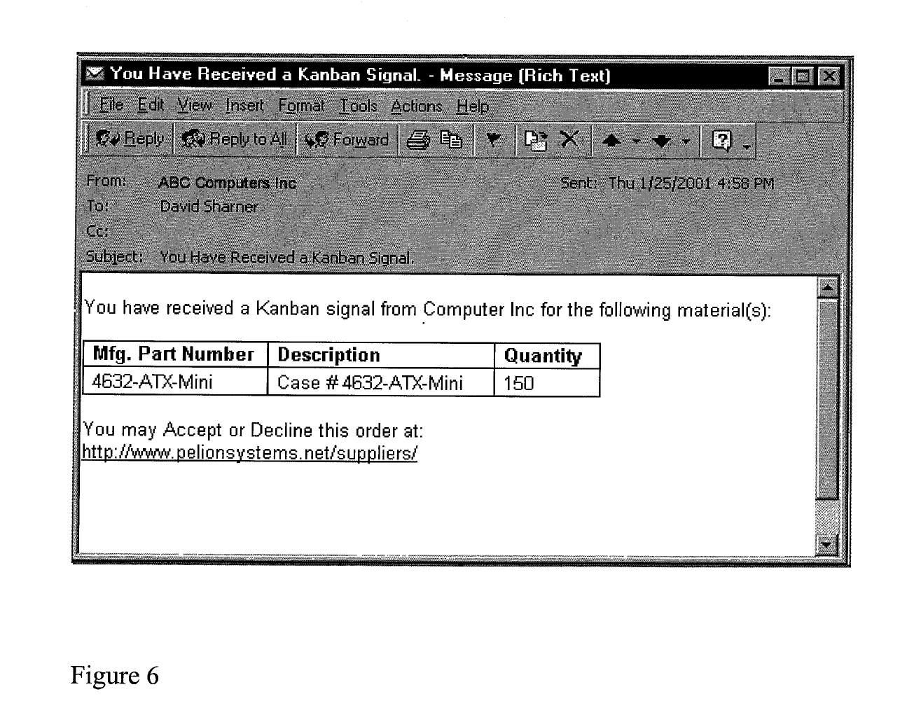

When signal states change, when alerts are generated due to overdue replenishment, or when other exceptions occur, a notification can be sent out by the system. These electronic notifications can take on many different forms. These include, but are not limited to, email, fax, mobile messages, EDI and XML. In its current form, the CFM system uses web-based user interfaces for reviewing and managing signals. FIG. 6 shows an example of an email-based replenishment signal.

### Performance and Conformance

Monitoring the performance and conformance of signals is also very important. This information can be used to determine overall effectiveness of the replenishment system, help set realistic expectations, and provide visibility in to problems in the replenishment process. Performance and conformance can be analyzed for a specific consumption point, supply point, and by the material or resource being replenished. This is useful since a supply point that has poor performance may indicate the need for choosing a new primary supply point.

In CFM, performance is a time-based measure, whereas conformance is a quantity-based measure. Performance uses the expected signal timeline, mentioned in the previous section, and the actual signal timeline for comparison. This indicates how well the replenishment process is meeting expectations on fulfillment time.

Conformance does a comparison of the quantity requested when the signal was initiated to the quantity that was finally received including what was accepted or rejected. This kind of a measure can help to show where problems are arising due to mistakes by the supply point, inability to meet demand by the supply point, or issues with quality. Below are some of the measures that can be derived for performance and conformance measurement. This list will continue to expand as the CFM system is enhanced.

Total Signals
Number of On Time Deliveries
Percentage of On Time Deliveries
Number of Late Deliveries
Percentage of Late Delivers
Average Time for Receiving
Best Time for Receiving
Worst Time for Receiving

Exemplary performance measurements include, but are not limited to:

Exemplary conformance measurements include, but are not limited to:

Total Quantity Received
Total Quantity Accepted
Percentage of Quantity Accepted
Total Quantity Rejected
Percentage of Quantity Rejected
Total Signals
Signals Meeting or Exceeding Quantity (Accepted + Rejected)
Signals NOT Meeting or Exceeding Quantity (Accepted + Rejected)
% of Signals Meeting or Exceeding Quantity (Accepted + Rejected)
% of Signals NOT Meeting or Exceeding Quantity (Accepted + Rejected)
Signals Meeting or Exceeding Quantity (Accepted Only)
Signals NOT Meeting or Exceeding Quantity (Accepted Only)
% of Signals Meeting or Exceeding Quantity (Accepted Only)
% of Signals NOT Meeting or Exceeding Quantity (Accepted Only)
Number of Declined Signals
% of Declined Signals

Reports for these measures are usually run for a given time period and the results are often shown on a graph.

### Kanban Sizing

When performing demand-based material replenishment, one of the most important aspects to consider is determining quantity of materials or resources to request in a replenishment signal. Since the inception of Kanban, a basic equation has arisen for determining the size of the Kanban quantity. The Kanban quantity is the amount of materials or resources required to produce enough product to meet demand during the amount of time required for replenishment.

Specifically, for a given part, the bill of materials for a finished good is exploded to determined the quantity of that part required to produce the given finished good. That is multiplied by an expected level of demand per day for that finished good. This is repeated for all of the finished goods being produced and the results are summed together. This sum is multiplied by the replenishment time for that material or resource, and this produces the final Kanban sizing.

D=The demand per day for a given finished good.

Q=The bill of material quantity of the part for a given finished good.

R=The replenishment time in days.

K=The Kanban quantity.

N=The number of finished goods used in this Kanban sizing.

$$K = {\sum }_{i = 1}^{N} ( Di * Qi ) * R$$

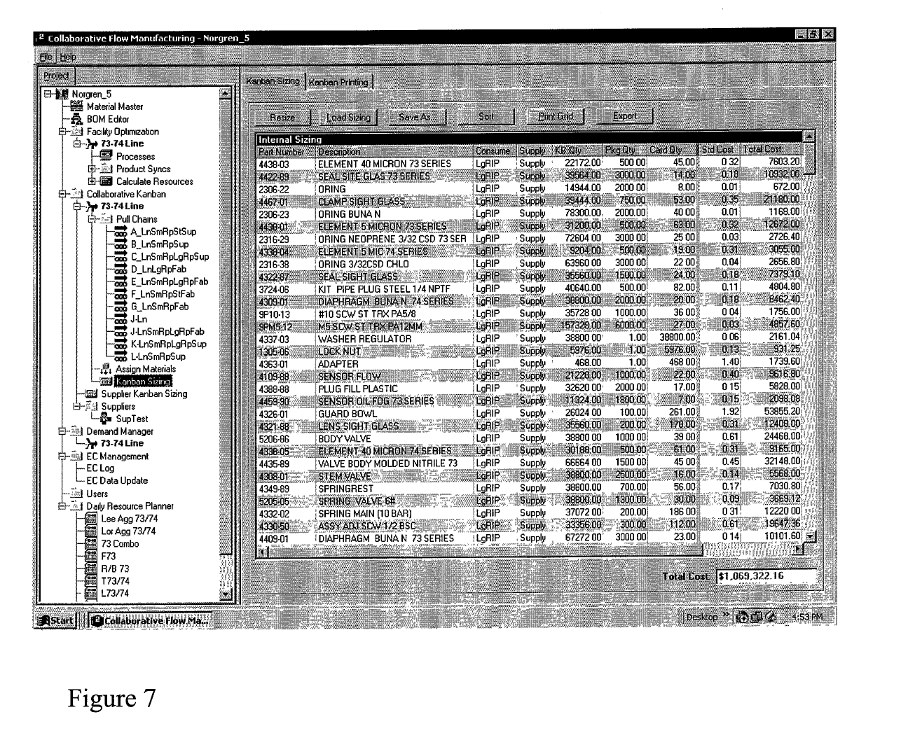

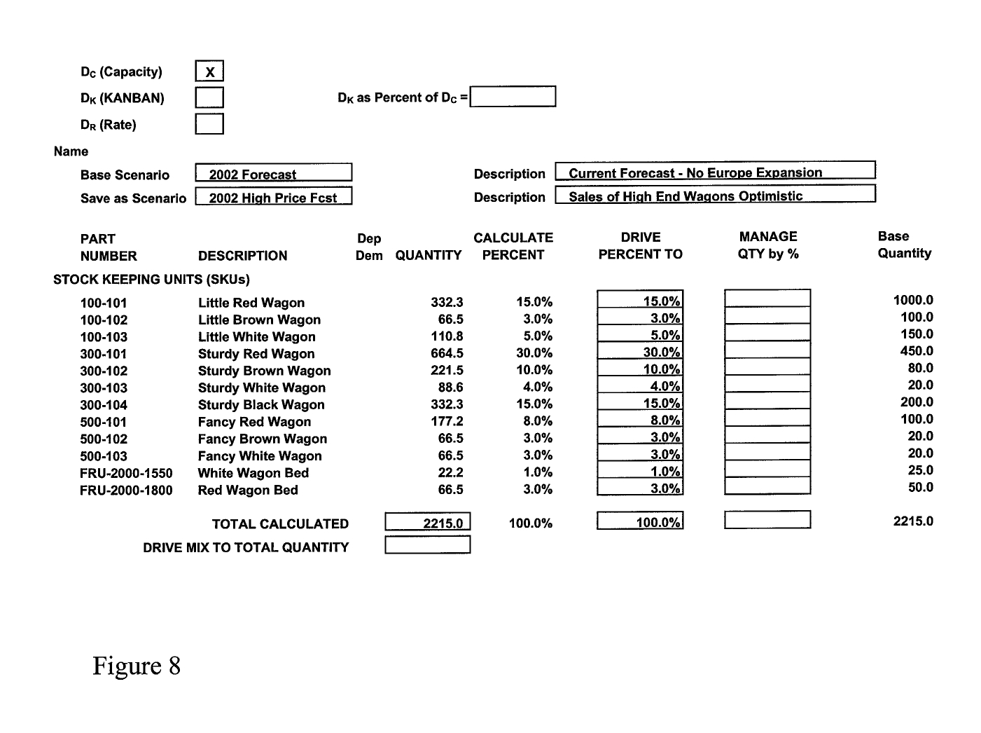

CFM uses the expected signal timeline for receiving of a given material or resource as the replenishment time. This produces a Kanban quantity that can be used for replenishment. Various demand levels can be used to analyze the impact to inventory levels and customer services levels. FIGS. 7 and 8 show completed Kanban sizing reports.

### Triggering Signals & Receiving

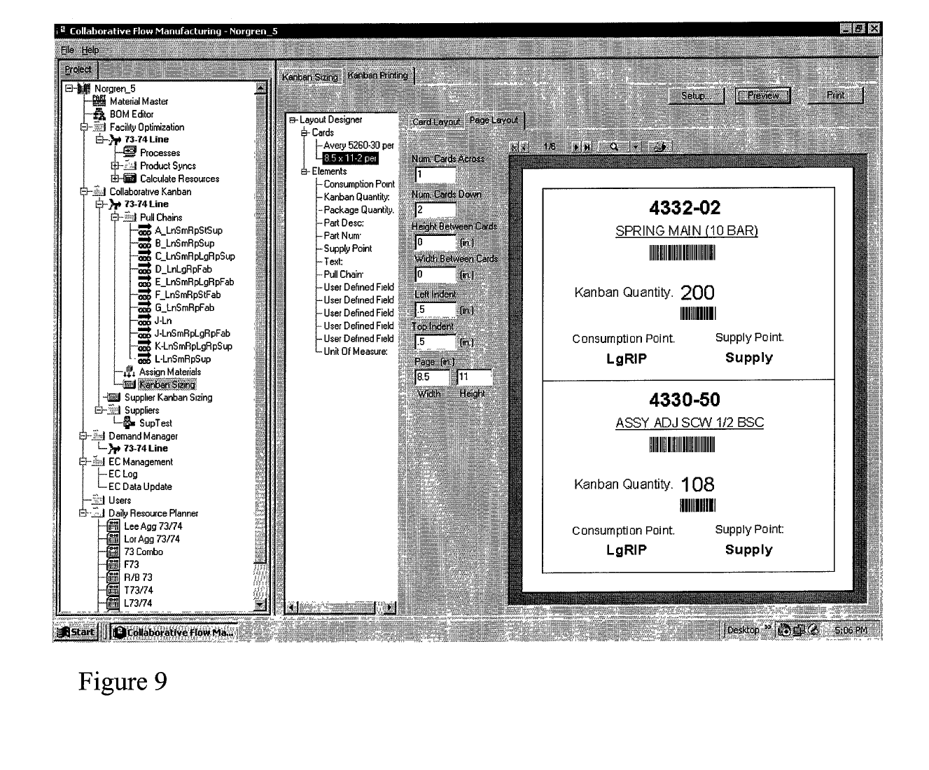

Determining when to trigger a replenishment signal is vital to a demand-based replenishment system. The CFM system provides several ways to initiate signals which all have situations to which they are best suited. The most basic Kanban uses visual signals, such as a light or empty container. This signals a material handler to come and replenish the container. Often a Kanban card is placed on or near the container to give the material handler instructions on where and how to replenish the given container. FIG. 9 shows an example of Kanban cards.

Because many facilities handle thousands of materials, these Kanban cards can be difficult to maintain and changes to demand can necessitate a lengthy process of replacing all of these Kanban cards. To help solve this problem, the CFM system provides the ability to use a machine-readable label to retrieve the Kanban information. Some examples of machine-readable labels include, but are not limited to, barcodes and radio frequency identification (RFID). This allows for labels to be produced once and Kanban information, such as quantity, to be dynamic. The device that reads the machine labels could also display the Kanban information to the material handler. FIGS. 7 and 9 show some of the typical Kanban information.

Machine-readable labels also provide a mechanism for triggering a replenishment signal. When a material handler sees that a container is empty or inventory has dropped below a threshold, scanning the label could trigger the signal.

Another mechanism for triggering a replenishment signal takes advantage of existing Inventory Management systems in a facility's ERP or MRP system. By periodically reviewing the inventory levels of specific materials or resources, the CFM system can trigger a replenishment signal. Further, one way to set this threshold is to use the Kanban quantity for a given part. This is of benefit to many facilities because they can continue to handle materials with their existing Inventory Management system and enable demand-based replenishment.

Some replenishment signals may need to be generated but are not based on inventory levels or consumption. There are a number of reasons these signals may be generated including erratic demand, specialized product orders, low volume parts, etc. To enable this kind of replenishment, the CFM system integrates with the existing Purchasing system of a facility's ERP or MRP system. When a purchase order or purchase order release is created in the purchasing system, a corresponding replenishment signal is generated. The CFM system then will continue to update information on the progress of the signal in to the Purchasing system. Conversely, changes to a purchase order attached to a signal may update the signal.

This integration with the Purchasing system also allows for purchase orders or purchase order releases against blanket purchase orders, to be created. This occurs when the signal is executed to a specific supplier and will keep the Purchasing system synchronized with the replenishment processes of the CFM system.

To continue taking advantage of existing ERP and MRP systems in a facility, the receiving function in the CFM system uses the Purchasing system or Inventory Management system. When a material or resource is received, a receipt record will be created in the ERP or MRP system as usual. The CFM system will recognize this receipt record and reconcile it with the corresponding signal. This will provide receiving information for the replenishment signal.

### Product Synchronizations

Product synchronization is a commonly used method of describing the flow of product or work through a series of processes as described in The Quantum Leap . . . in Speed to Market, Third Edition, by John R. Costanza, 1996.

The contents of Mr. Costanza's book are incorporated herein by reference. The term “value stream map” is also commonly used to describe these relationships as defined in Lean Thinking—Banish Waste and Create Wealth in Your Corporation by James P. Womack and Daniel T. Jones, 1996. The contents of that book are incorporated herein by reference. This functionality is provided by the Facility Optimizer in the CFM system.

Product synchronizations can be used in many situations. In a manufacturing facility, the product synchronization describes the movement of product through the different processes required to transform the raw material into a final product. An example of a manufacturing product synchronization would be to model the assembly of a toy wagon.

Different processes are used to build the component parts such as frame, wheels, handle, body and so on. Then, as the wagon moves down an assembly line, the manufactured and purchased components are added to produce a final product that matches the specification. Scrap and rework may occur at various processes and optional flows are possible depending on the features and specific product configuration required.

In an office environment, the product synchronization can represent the flow of a document (paper or electronic) as information is added or analyzed at the different processes required. An example of an office product synchronization would be completing a loan application. In this case, different information is added at each step of the process such as name, address, employment verification, credit history, reference checks and so on. At various points, an analysis process may take place such as calculating a credit rating. Rework may occur at various stages as potential problems are identified and resolved.

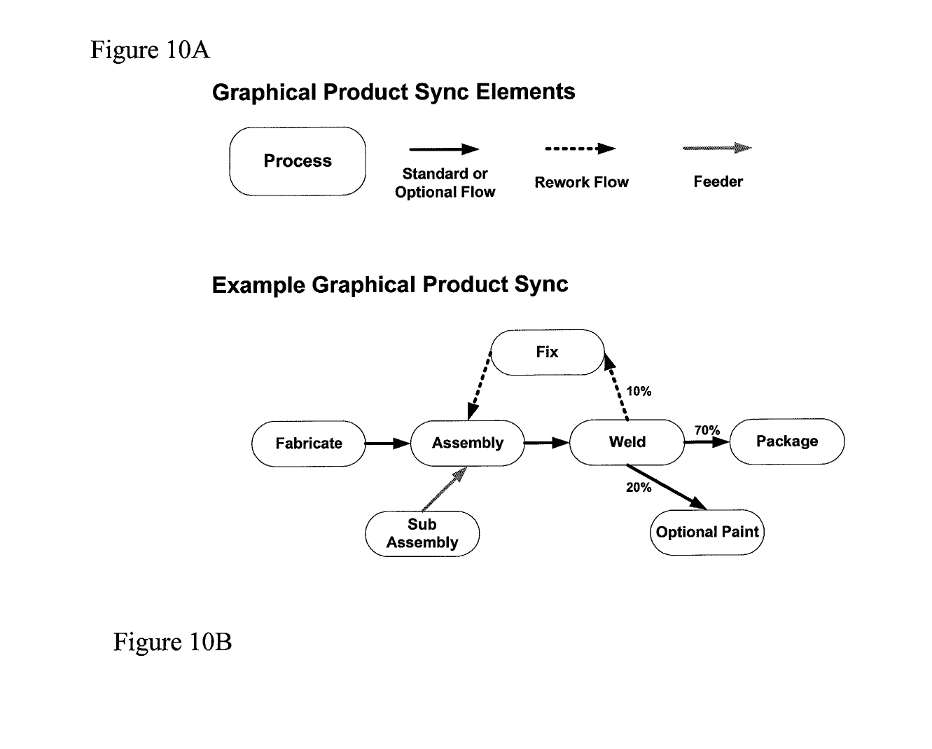

The CFM product synchronization feature uses defined graphic elements to illustrate the various types of flow between processes. These elements are shown in FIG. 10. These graphic conventions allow users to quickly understand the fundamental flow of complex processes.

The elements are as follows (product refers to any kind of product of work):

| | |
|---|---|
| Process | A process is a set of operations done to produce a product. To |
| | create resource sizes, times for each resource are often stored |
| | with this process. |
| Standard | A flow connecting two processes where all of the products of |
| Flow | the first process flow in to the second process. |
| Optional | Similar to a standard flow except that only a percentage of the |
| Flow | products flow to the second process. A process that has an |
| | optional flow will usually connect with more than one |
| | process. |
| Rework | When products must be fixed or reworked, this is indicated by |
| Flow | a rework flow. A percentage of the products produced in the |
| | process that are reworked is also specified. |
| Scrap | The amount of product that is scrapped and does not continue |
| | on to any additional processes. Scrap is specified as a |
| | percentage also. |
| Feeder | A flow that merges a process with the main flow of work. In a |
| | manufacturing environment, this could be a set of wheels |
| | produced in a feeder process that are then joined with |
| | the main production line. A feeder can also have a |
| | percentage attached. |

A benefit that the CFM system delivers is the ability to develop graphical product synchronizations using a computerized set of drawing and data entry tools. As information regarding each process is entered, the system generates graphical diagrams and allows the user to manipulate the diagrams on the screen.

The data and relationships between processes are captured and becomes the basis for modeling the product flow and determining the final resource size required to meet a given demand. Graphics tools allow the user to manipulate the diagram and produce a meaningful representation of the product flow.

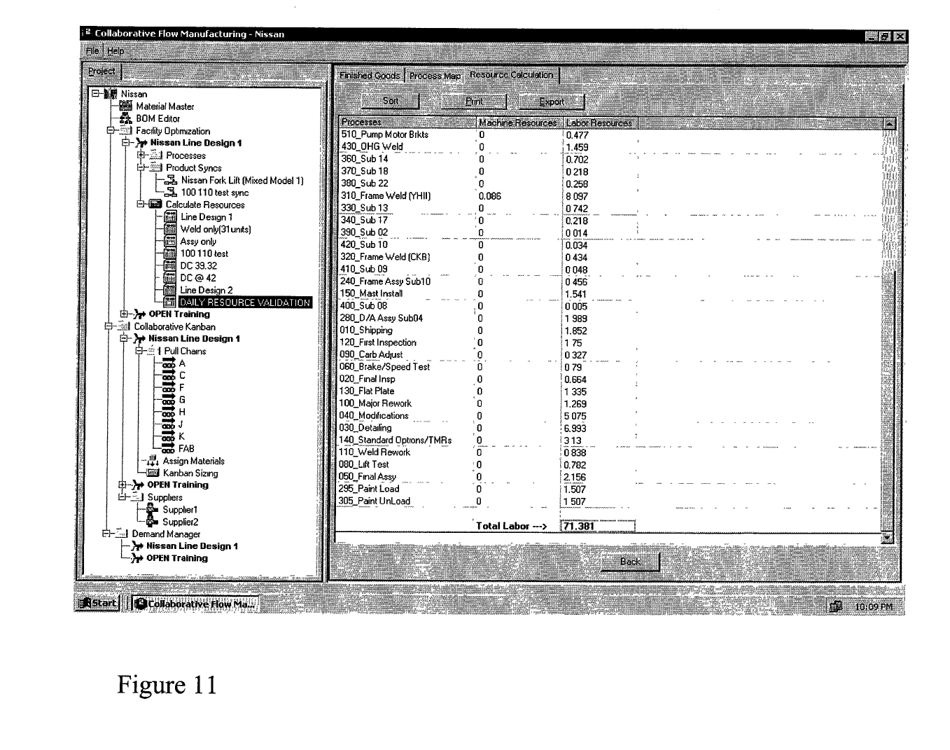

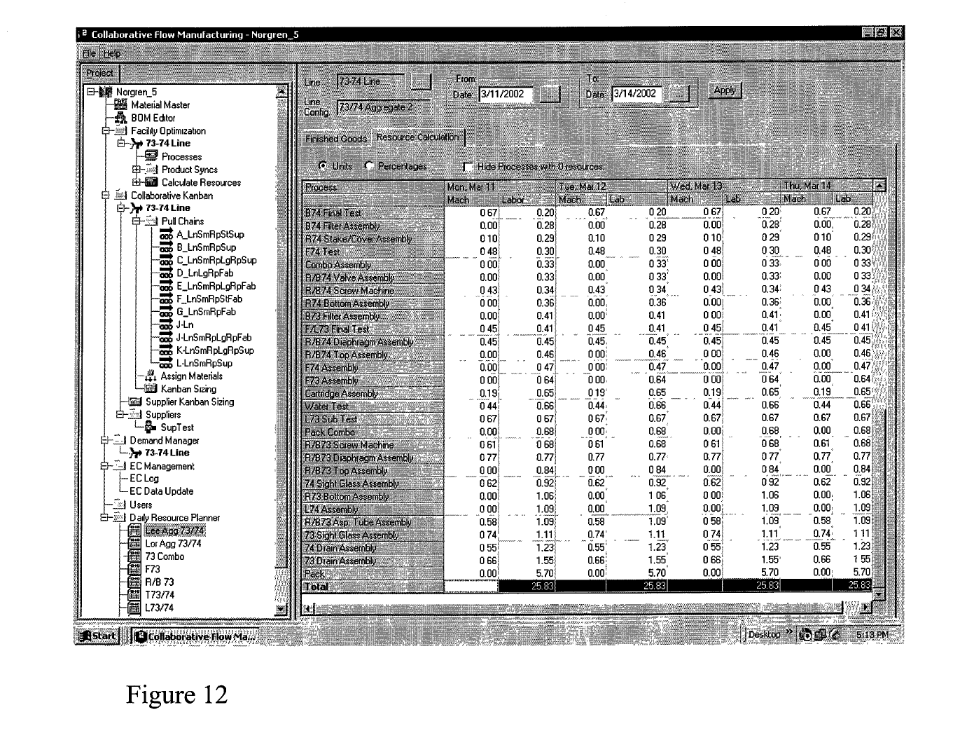

The process information and connections of flow are used to determine the various rates at which products will flow through the processes. The CFM system takes this data and solves the system of equations produced from the data to get these rates. The rates can then be used to calculate how many resources for both machine and labor, are required to produce a given demand. See FIGS. 11 and 12 for examples of the resources sizes produced.

Once the flow ratios have been calculated, the resource sizes can then be calculated. For a particular line design, finished goods are assigned to product synchronizations and given specific demands at capacity. The processes have average times for labor and machine resources, which can be overridden for a specific finished good. Machine and labor each have there own average times and produce separate resource sizes. This explanation will cover calculating for one resource, but the process can be applied to as many resources as necessary.

Here are definitions of the variables used in this calculation:

R—The resource size, which is a multiple of the number of resources required to meet DC. A particular R is for a single process and resource attached to that process.

DC—The demand at capacity. This is the number of units to be produced of a given finished during a specified time period, typically one day.

AT—The average time for a process to complete. The average time is by process and a specific resource, such as machine or labor, and also it can also be specified for a particular finished good. ET and AT must be in the same units of time.

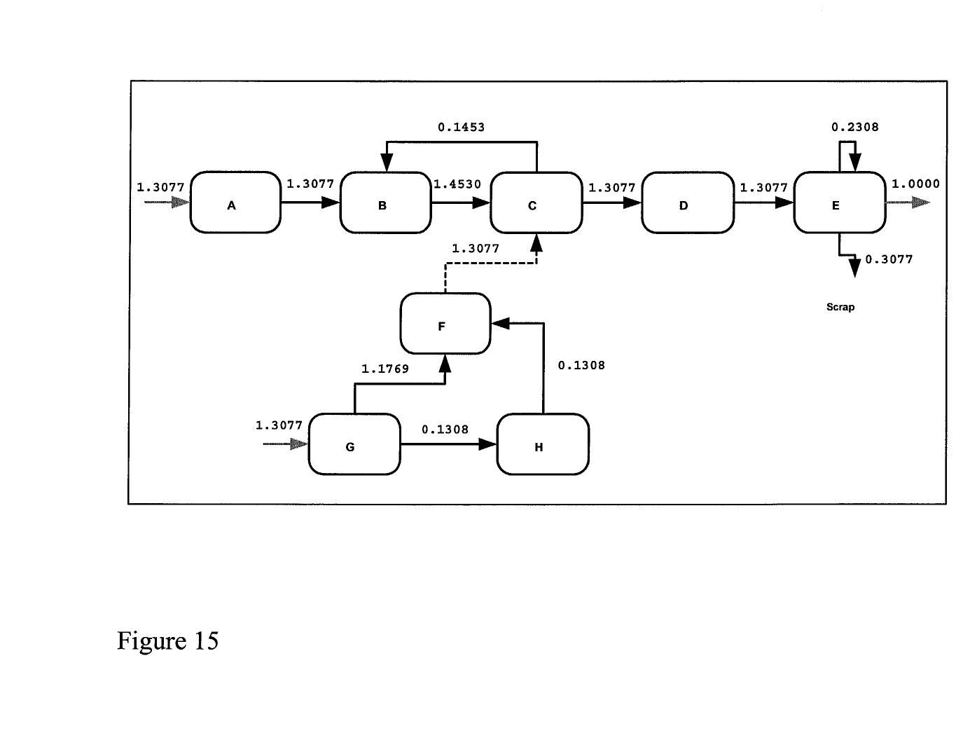

P—The process multiple is the adjusted amount of goods a process must produce. This is where the flow ratios come in to play. Each process must produce the multiple of DC that is derived from the flow ratios. A process must produce enough goods to account for all of the required output. So P is calculated by summing all of the output flow ratios for the given process AND product sync. Remember that there will be one P for each product sync a process is assigned to. Here is an example for process C shown in FIG. 15:×4=1.3077×5=0.1458, so P=|×4|+×5|=1.4535

ET—Effective time is the amount of effective time available for the time period used by the DC. So if the DC is for the time period of a day, the effective time might be 8 hours. The effective time can be a global number or it can be overridden for a specific process. The ET must be in the same units of time as the AT.

Resource sizes (R) are calculated for each resource assigned to a process with in a line design. We first start with a particular process and resource. We will look at all of the product syncs that the process is assigned to and get the process multiple (P) from that product sync's flow ratios. Then we will get each finished good assigned to the product sync. With each finished good we will multiply the following: the process multiple (P) for the current product sync; the demand at capacity (DC) for this finished good; and the average time (AT) to complete the process for the resource, which can be overridden for this finished good. Each process, product sync, finished good combination is summed and divided by the effective time (ET). The following equation represents this:

$$R = \frac{{\sum }_{x = 1}^{N} ( ATx * DCx * Px )}{ET}$$

Another benefit of the CFM system is the ability to combine multiple individual product synchronizations into a complete mixed model flow. This allows users to visualize the complex relationship of processes that often exist in a large operation or organization. Furthermore, by defining the relationship of processes, the system can calculate the sum of all demands from all products. This ability to track demand for each process in a mixed model flow provides the user with the functionality described earlier in the section regarding Facility Optimizer.

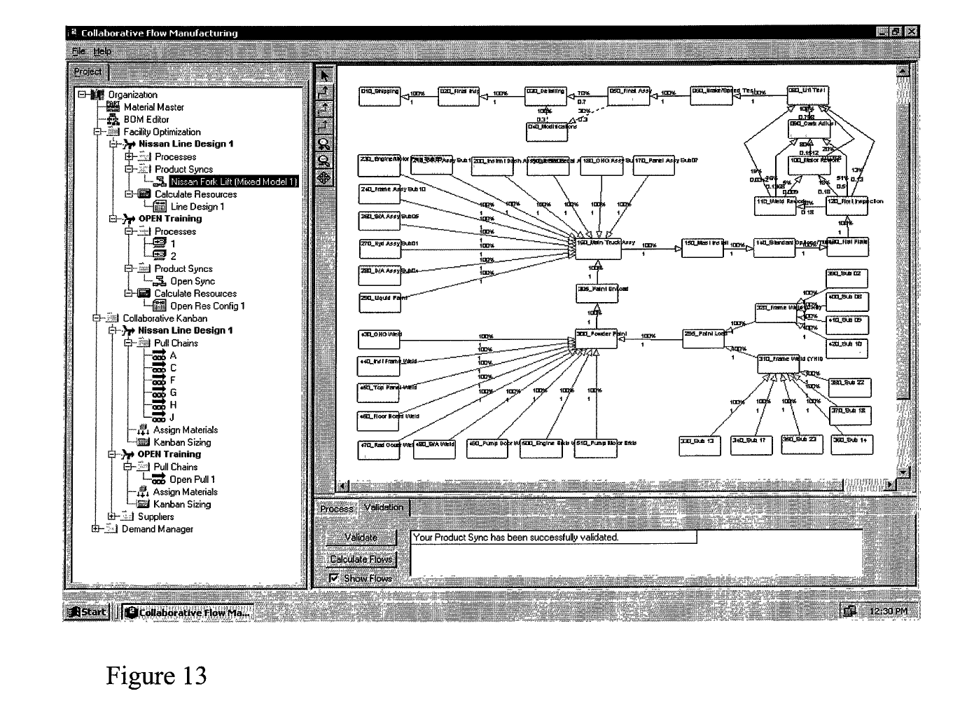

This graphical mixed-model product synchronization uses an algorithm to layout the processes while minimizing the distance between processes and the intersection of the flow lines. FIG. 13 shows an example of a graphical mixed-model product synchronization.

Unique challenges are presented when calculating kanban sizes and managing kanban pull systems for fabrication processes and cells that are not directly connected with the main flow of assembly. Generally, a system designer should consider inventory sizing and management to allow for sizing a fixed replenishable quantity while considering all time required to produce, set-up, wait, and transfer to a consuming process based on customer demand. Exemplary manufacturing factors to be considered are described below, but it should be appreciated by those of ordinary skill in the art that additional factors may also be included in the overall design of a manufacturing or production system.

(1) Kc Max

Kc Max is calculated when more than one process/resource exists in the pull chain. When different processes/resources are required to produce a single product, Kc Max takes into consideration where these processes/resources have different set-up times and different run times. To calculate Kc, (fixed Kanban quantity needed to recover set-up) for each resource would result in a unique Kc for each resource. Fabrication Kanban will calculate each Kc per resource with a highest or Max Kc quantity calculated being rolled back through the pull chain.

(2) Rc queue/wait

Rc queue/wait is replenishment time calculated including queue and wait time. A Wait/Work board is often used to manage actual kanban signals for fabrication processes. The wait side of the Wait/Work board organizes signals until a sufficient demand is accumulated to signal work. The work side of the ThisWait/Work board then orders these accumulated kanban signals in a first-in-first-out fashion, or in an ordering method that optimizes customer response and asset utilization. The Rc factor considers that when the Kanban card(s) transfer to the Work side of the Wait/Work board, the work does not necessarily start immediately. Where many products are manufactured/produced on the same machine resource in a high model mix environment, it is likely that when the signal to produce the Kanban quantity (Kc) is complete there will be other Kanban cards for other products queued in front in a FIFO order or another appropriate order. The result is a queue and wait time to be produced. If this is not taken into consideration then the calculated replenishment time to replace the quantity back to the Raw and In-Process Inventory, (R.I.P) will be understated. This will result in under-sizing inventory requirements to support downstream demand. Rc queue/wait time analysis can be used to account for non-replenishable parts being produced along side of Kanban parts. Therefore, all produced parts and times are factored into the analysis allowing for Fabrication Kanban to output which strategy to adopt, (replenishable, or non-replenishable).

In other applications, the decision to define an item as non-replenishable is handled separately from calculating Kanban. Fabrication Kanban must consider all parts consuming the resource in order to consider all demand requirements for products produced. Deciding beforehand which parts will be non-replenishable and not included in Kanban sizing would incorrectly size the replenishable Kanbans. Fabrication Kanban effectively considers all demand and time considerations against the production resource(s).

The present invention is also preferably capable of calculating the manufacturing lead-time to set up and produce all products attached to a pull sequence. This enables the system to calculate the additional time for queuing and waiting time.

(3) Current Order Filter

Current Order Filter (COF) takes into consideration current orders in production. Mixed Model Flow Line Design considers all demand for all products in calculating or utilizing a resource. However, day-to-day production will not have active orders for all products produced on the resource. This means CFM line designs have the capability to produce every model every day, but day-to-day Fabrication Kanban considers how many of those parts are required to be produced to support the active orders. COF ensures ‘Strategic’ dependant demand is produced and prevents consuming machine and labour resources producing something that is not currently needed. This also ensures that the Rc queue/wait is not unduly inflated by considering parts which will not be on the Wait/Work board. This will of course also ensure the Kc replenishment quantities are also not unduly oversized. It is also possible to use a factor to take active orders into consideration and consequently adjust the Kc accordingly.

(4) Multi-level Kanban

Multi-level Kanban takes into consideration part number changes during manufacturing. By taking multi-level bills of material into consideration where the part number changes as the piece goes through the manufacturing process, Kc can be calculated to part number specific at the producing resource. The system will allow for initial Kc/Part sizing to follow a piece through the BOM structure even though part number changes occur through the levels. The system tracks the different levels and the association of the (Parent/Child) relationship. Fabrication Kanban will calculate Kanban for each part number change and through the B.O.M structure and apply Kc max to create 1 Kc quantity for the physical part.

(5) Kanban Process Mapping

Line design information can be used to define resource consumption. This reduces the number of Kanban pull sequences and takes into consideration that every part does not consume every resource in the pull sequence chain. In Fabrication Kanban, the calculation of Rc looks into the process map part specific, with the intent to know exactly how many parts are consuming each resource. This also ensures the queue/wait time for each resource is accurate. This gives the ability to have generic pull chains, as a pull chain is not needed for every part with a slightly different manufacturing path.

(6) Recommendation and Sizing Factors

The system of the present invention preferably mathematically calculates and recommends a Kanban method or methods that should be adopted. Once all relevant data is known about a method, Process/Resource specifics including whether or not set-up recovery is required can be determined. If the recommendation is ‘Yes’, then by specific part numbers, Single, Dual or non-replenishable Kanban cards are produced. The specific quantities to recover set-up can also be calculated. The calculated quantities also take container size into consideration even if the sizes differ between the machining area and RIP and between RIP and assembly.

Exemplary benefits of using Fabrication Kanban as discussed above:

(1) Kanban sizing performed empirically with a consistent set of formulae which allows for the impact of set-up reduction or reduction in work content time to be seen instantaneously.

(2) Kanban can be used to enhance Inventory Turn over by ensuring only the quantity to recover set-up is produced, therefore the producing process does not spend time consuming Labor/Machine resource producing pieces that are not needed and efficiency is improved.

(3) The replenishment of Kanban is driven by consumption of Assembly, which more closely approximates customer demand than traditional MRP scheduled fabrication work centers. The recovery quantity will always be the same, until recalculated by the factory designer. This avoids the MRP situation which has demand including forecast data that is often incorrect. Moreover were a forecast to be included, often dependant demand is produced even when a corresponding order is never received or is received but higher or lower than forecasted. This again results in improper resource allocation.

(4) The impact of demand changes can be easily simulated in Fabrication Kanban and the resultant ‘New’ Kanban sizes viewed. This change can be kept as a simulation or accepted to accommodate this change. This allows decisions to be made on what the aftermath of the change would be in terms of Machine/Labor resources or increased inventory investment.

(5) The planning effort required by fabrication managers is dramatically reduced as once the cards are in circulation the system is largely self-managing. The only intervention is for non-replenish able ‘Make to order’ parts, or when significant changes or improvements to the process are implemented. The daily expediting, prioritizing, and troubleshooting that comprise significant work effort in an MRP scheduled configuration are dramatically reduced using the Fabrication Kanban method.

For Internal Kanban the Replenishment time R is defined by supplier capability and the logistics of moving parts within the factory. For Fabrication Kaban, calculating R must now take into account not only the time to move the parts from the supplying location to where they are needed, but also the amount of time it takes to produce the parts, recover the lost setup time to setup the machine, as well as the time the parts needed must wait for other work to be completed on the machine. This process demonstrates how to calculate that Rc for the fabrication process.

Minimum Cell Replenishment Qty Calculation: Kc

Max # Setups/Day=(Minutes Avail for Setup/Average Setup)

Dk Current Kanban design demand in produced units

Kc Total production time consumed by setups in a day (where Kc is given by Kc=Dk×(Setups required/Max # Setups/day)

Kc Max=Largest Kc where more than one process required in cell to produce item

Produce Bin Qty is user defined based upon container size, part dimensions and weight

H(M) Effective Minutes of working time in a shift

R Replenishment time to deliver required materials

SU Setup on gating machine

Rt Run time of all machines

Rtp Run time of pacing machine

Rc=(Sum(SU+Rt)+(Rtp * (Kc−1)))

Rc Que Wait Time that cards wait on the work side of the board for production

Sum Rc Sum of all products produced in machine cell

Item Rc Individual replenishment time for product kanban is being designed for

Rc Que Wait=((Sum Rc−Item Rc)* 0.2))+Prod Rc

WTQ Waiting Time Quantity (WTQ) is the additional number of pieces to ensure the downstream process does not run out of parts due to waiting time on the Wait/Work board

WTQ=Dk*(Rc Que Wait Replenishment Minutes)

TRQ Total Replenishment Quantity

TRQ=KcMax+WTQ

RIP Kanban Sizing: K Consuming Process from Upstream UFL

Use the standard Internal Kanban formula except use “Rc” in place of R

K=(D×Q×R)/Pkg Size

Rc=(Sum(SU+Rt)+(Rtp*(Kc−1)))

NRDF=Non Replenishable Demand Filter

Lowest product demand size that the factory is willing to design kanban for

Recommendation Decisions:

If Dk is less than NRDCF then use a Non Replenishable KB, not Fab KB

If K, (RIP Kanban)>TRQ than use the regular Internal Kanban method

If TRQ>K then use the Fabrication Kanban method with TRQ as the

total parts in the system

Produce Quantity=Kc Max

Number of Cards=TRQ divided by Produce Bin Qty

Number of Cards to Signal=Kc Max divided by Produce Bin Qty

Additional capabilities and/or outgrowths of the system include, but are not limited to, (1) Accountability for Entire Replenishment Time, (2) Filtering capability for Likely to Produce, (3) Acknowledgement of Queuing between Production and Consuming Processes, (4) Effective Machine and Labor resource utilization, (5) Inventory reduction, (6) Multi-level Bill and part number change support, (7) Strategic stock, (8) Self managing production sequencing, (9) shipping performance improvement, and (10) Calculations and Kanban recommendations are tied directly demand from the consuming processes and key process variables (KPV's).

Numerous modifications will become evident to those of ordinary skill in the art from the specification. Accordingly, the specification is not meant to be limiting, and only the appended patent claims define the scope of protection afforded to the inventors.

1. A computer-implemented method for managing a lifecycle of notification signals for replenishment of a good from a supply point to a consumption point, the method comprising the steps of:
initiating a good notification signal from a consumption point that replenishment of a specified good is requested;
transmitting a request notification signal to a supply point;
determining, by the supply point, whether the specified good can be delivered by said supply point;
transmitting, by the supply point, a shipping notification when the specified good is sent to the consumption point;
receiving, by the consumption point, a delivery notification when the specified good arrives; and
changing a state of the good notification signal to closed when the good notification signal has been fulfilled,
wherein the state of the good notification signal is stored and can be viewed after the step of initiating.

2. The method of claim 1, wherein the signal state comprises at least one of a name, an item number, and a quantity of the specified good to be replenished.

3. The method of claim 1, further comprising the step of canceling, by the consumption point, the good notification signal.

4. The method of claim 1, wherein the step of determining further comprises the step of declining the request notification signal.

5. The method of claim 4, further comprising the step of determining an alternate supply point when the supply point declines the request notification signal.

6. The method of claim 5, wherein the step of determining an alternate supply point comprises determining the alternate supply point based on a cost of the specified good.

7. The method of claim 5, wherein the step of determining the alternate supply point based on a cost comprises determining the alternate supply point based on a cost of the specified good and a cost of downtime of a manufacturing line until an expected delivery of the specified good by the alternate supply point.

8. The method of claim 5, wherein the step of determining an alternate supply point comprises determining the alternate supply point based on a delivery time for the specified good.

9. The method of claim 1, wherein the step of transmitting the request notification signal comprises transmitting plural requests for an amount of the specified good from a plurality of supply points.

10. The method of claim 1, wherein the step of transmitting a shipping notification comprises transmitting plural shipping notifications from plural supply points in order to fulfill a single good notification signal.

11. The method of claim 11, wherein the step of changing the state comprises changing the state to closed only after receiving plural shipping notifications from plural supply points in order to fulfill a single good notification signal.

12. The method of claim 1, wherein the step of receiving a delivery notification comprises storing a quantity received of the specified good.

13. The method of claim 1, wherein the step of receiving a delivery notification further comprises storing a quantity rejected of the specified good.

14. The method of claim 12, wherein the step of transmitting a request notification signal to a supply point comprises selecting the supply point from plural supply points based on a historical analysis of the quantity received of the specified good from the supply point versus a quantity ordered from the supply point.

15. The method of claim 13, wherein the step of transmitting a request notification signal to a supply point comprises selecting the supply point from plural supply points based on a historical analysis of the quantity rejected of the specified good from the supply point versus a quantity ordered from the supply point.

16. The method of claim 1, wherein the step of transmitting a request notification signal to a supply point comprises selecting the supply point from plural supply points based on a historical analysis of an estimated time to receive the specified good from the supply point versus an actual time to receive the specified good from the supply point.

17. The method of claim 1, further comprising:
providing a timeline for each supply point and good specifying an expected amount of time from the step of initiating until each other step in the method; and
storing, for each step in the method, a time elapsed since the good notification signal was initiated.

18. The method of claim 17, further comprising the step of alerting at least one of the consumption point and the supply point when more time than expected has elapsed for at least one of the steps of the method based on the timeline.

19. The method of claim 8, further comprising:
calculating a Kanban quantity based on a total expected replenishment time for the specified good based on the timeline, wherein the step of transmitting a request notification signal comprises transmitting a request notification signal for a quantity of the specified good equal to the Kanban quantity.

20. The method of claim 8, further comprising:
calculating a Kanban quantity based on a total expected replenishment time for the specified good based on the timeline, wherein the step of transmitting a request notification signal comprises transmitting a request notification signal for a quantity of the specified good equal to the Kanban quantity times a factor greater than one to compensate for a change in demand.

21. The method of claim 20, wherein the step of initiating comprises initiating the good notification signal when a total quantity of inventory for the specific good stored in an inventory management system falls below the Kanban quantity.

22. The method of claim 20, wherein the step of initiating comprises initiating the good notification signal when a total quantity of inventory for the specific good stored in an inventory management system is predicted to fall below the Kanban quantity within a specified time period.

23. The method of claim 22, wherein the specified time period comprises a current work day.

24. The method of claim 22, wherein the specified time period comprises a current work week.

25. The method of claim 1, wherein the step of initiating is triggered by a step of generating at least one of a purchase order and a purchase order release in a purchasing system.

26. The method of claim 1, wherein the step of transmitting a request notification signal comprises transmitting, from a purchasing system, at least one of a purchase order and a purchase order release against a blanket purchase order.

27. The method of claim 1, wherein the step of receiving a delivery notification is triggered by storing, in a purchasing system, a purchase order receipt record indicating at least one of a quantity received and a quantity rejected of the specified good.

28. The method of claim 19, wherein the step of calculating a Kanban quantity comprises scanning a machine-readable Kanban label.

29. The method of claim 28, wherein the step of scanning a machine-readable Kanban label comprises scanning a machine-readable Kanban label that does not include a Kanban quantity.

30. The method of claim 28, further comprising reading a quantity to be ordered from a storage device based on data obtained from scanning the machine-readable Kanban label.

31. The method of claim 28, further comprising reading a quantity to be ordered from a database based on data obtained from scanning the machine-readable Kanban label.

32. The method of claim 30, wherein the step of reading a quantity to be ordered further comprises reading at least one of a part number, an identification of the supply point, and an identification of the consumption point from the storage device.

33. The method of claim 31, wherein the step of reading a quantity to be ordered further comprises reading at least one of a part number, an identification of the supply point, and an identification of the consumption point from the database.

34. A machine for reading machine-readable Kanban labels, the machine comprising:
a Kanban label scanner for scanning a machine-readable Kanban label that does not include a Kanban quantity;
a transmitter for transmitting an identifier read from the machine-readable Kanban label to a storage device; and
a receiver for receiving, from the storage device, at least one of a part number, an identification of the supply point, an identification of the consumption point and a Kanban quantity corresponding to the identifier read from the machine-readable Kanban label.

35. The machine of claim 34, wherein the storage device comprises a database.

36. A computer-implemented method for visually defining a product synchronization, the method comprising steps of:
a. adding nodes to a diagram to represent processes of the product synchronization;
b. adding connected lines between nodes to a represent flow of products;
c. assigning a percentage of process output to each flow;
d. generating flow ratios based on input processes and flows; and
e. calculating required resources for the processes of the product synchronization using said flow ratios.

37. The method of claim 36, wherein the flow comprises one of a rework flow, a feeder, a standard flow, and an optional flow.

38. A computer-implemented method for viewing a plurality of product synchronizations as one visual diagram that is a graphical mixed-model product synchronization, the method comprising steps of:
a. combining a plurality of product synchronizations to product a single connected node graph in memory, wherein nodes represent processes and connections represent flows; and
b. placing nodes on a visual diagram while minimizing (1) distances between connected nodes and (2) intersections between nodes and connecting lines.
